(19) United States
(12) Patent Application Publication
(10) Pub. No.: US 2008/0162283 A1
(43) Pub. Date: Jul. 3, 2008

(54) METHOD OF ADVERTISING REAL ESTATE AND SIGNAGE FOR SAME

(76) Inventor: Sanjiv K. Jain, Erdenheim, PA (US)

Correspondence Address: SYNNESTVEDT & LECHNER, LLP, 1101 MARKET STREET, SUITE 2600, PHILADELPHIA, PA, 19107-2950, US

(21) Appl. No.: 11/962,954

(22) Filed: Dec. 21, 2007

Related U.S. Application Data
(60) Provisional application No. 60/871,728, filed on Dec. 22, 2006.

(51) Int. Cl. G06Q 30/00

(52) U.S. Cl. 705/14

(57) ABSTRACT

A method of advertising a particular property of real estate comprising preparing a sign particular to the particular property, the sign containing critical information which is unique to the particular property, not readily ascertainable by a person observing the property from a public vantage point, and critical to a potential buyer's decision to purchase the particular property and posting the sign proximate to the particular property.

### CROSS-REFERENCE TO RELATED APPLICATIONS

This application claims benefit of U.S. provisional patent Application Ser. No. 60/871,728, filed on Dec. 22, 2006, which is herein incorporated by reference.

### FIELD OF INVENTION

The present invention relates to the field of selling property, specifically, real estate, and, even more specifically, residential real estate.

### BACKGROUND OF INVENTION

The need to sell or rent property, in particular, real estate, has been present since the beginning of civilization. Over the last several centuries, firms have emerged to handle the sale of real estate and to facilitate its transfer. (It should be understood that the term “real estate firm,” as used herein, is intended to cover broadly all people and companies involved professionally in the sale, rental or brokerage of real estate.) These real estate firms are generally agents of the seller, and are charged with the responsibility of advertising the property in question and otherwise finding suitable buyers for the property. Although advertising techniques used by such firms vary, typically they involve point-of-sale advertising (i.e., a sign located on the subject property), regional advertising, and, more recently, internet advertising. Of particular interest herein is point-of-sale advertising.

Interestingly, the primary objective of traditional point-of-sale advertising in the real estate field is to promote the name and contact information of the real estate firm. That is, the sign that is used by a traditional real estate firm is targeted to draw in potential buyers and make them clients rather than to sell the property. The theory behind this approach is that, even if the property in question is determined to be unsuitable to the potential buyer, the real estate firm has nevertheless made contact with the potential buyer, enabling the firm to show the potential buyer other properties which may be more suitable. With this objective, real estate signs display predominately the name and/or logo of the real estate firm along with contact information. If a potential buyer wants to know more about the property in question, he is expected to call the real estate firm.

Although traditional real estate advertising techniques for “pulling” in clients have proved effective, there continues to be a need to improve the efficiency of connecting buyers to sellers in the real estate market. The present invention fulfills this need among others.

### SUMMARY OF INVENTION

Applicant recognizes that the traditional techniques for “pulling” in clients may be effective for improving the real estate firm's exposure and for increasing its client base, but are not optimum for selling the property in question. Instead, applicant believes there is a need to “qualify” buyers and sellers upfront before initial inquiries are made. Specifically, “real” buyers want to know the details of a property before expending effort to investigate the property. For example, even though a buyer driving by a residential property listed for sale may suspect it is within his price range, he cannot sure. Applicant has found that this uncertainty may lead to a lack of determination on the buyer's part to contact the real estate firm for additional information. Likewise, sellers would prefer to deal only with real buyers, and not with people who are not qualified to purchase the property. For example, it would be more efficient if the real estate firm and seller only dealt with buyers who understood the price of a property before they called. Therefore, by not qualifying buyers and sellers upfront, real buyers may fail to follow up on well-suited properties, while sellers may have to deal with people who are not real buyers.

Applicant recognizes the need to qualify buyers and sellers upfront before the initial inquiry is made by the buyer. This is a paradigm shift from traditional approaches in which the real estate firm wanted people to call regardless of whether they were suitable buyers for the property in question.

Pursuant to qualifying buyers and sellers before the initial inquiries are made, applicant has developed a sign that provides critical information. Critical information is information which is (1) unique to the particular property, (2) not readily ascertainable by a person observing the property from a public vantage point, and (3) determinative in a potential buyer's decision to purchase the particular property. Critical information may include, for example, one or more of the following parameters: price; rent; number of bed rooms; number of bathrooms; area; existence of one or more of the following: finished basement, pool, carriage house, multiple buildings; subjective qualities such as clean, bright, and open; lot size; zoning information such as sub-dividability, easements, encumbrances, access, restrictions/variations; historical information; prominent architect or designer; recent improves such as remodeled kitchen, renovation; information on kitchen including countertop material, appliances; rental information rental history and relationships between price and rental income.

Applicant has found that by providing this information upfront only “real” buyers tend to initiate contact. Also, real buyers once this information is known are more likely to contact the real estate firm. Thus, the result is a greater number of real buyers contacting the real estate firm, thereby improving the chances for the property to be sold more quickly and at a higher price.

In addition to providing this critical information, applicant has found that better results can be obtained by displaying this critical information conspicuously. Applicant recognizes that, in today's world, most people passing real estate property are in vehicles and only have an opportunity to glance at the sign to ascertain the critical information. Therefore, by conspicuously displaying the critical information, potential buyers driving past the property are able to ascertain the relevance of the property immediately and qualify themselves as real buyers before following up with the real estate firm.

Accordingly, one aspect of the present invention is a method of advertising real estate at a point-of-sale by providing potential buyers with critical information about the property in question to allow them to qualify themselves before calling for additional information. In a preferred embodiment, the method comprises: (a) preparing a sign particular to the particular property, the sign containing critical information which is (1) unique to the particular property, (2) not readily ascertainable by a person observing the property from a public vantage point, and (3) critical to a potential buyer's decision to purchase the particular property; and (b) posting the sign proximate to the particular property.

Another aspect of the invention is a sign for prominently displaying critical information at the point-of-sale. In a preferred embodiment, the sign comprises: (a) a front surface; (b) an information box on the from surface, the information box containing only critical information which is (1) unique to the particular property, (2) not readily ascertainable by a person observing the property from a public vantage point, and (3) critical to a potential buyer's decision to purchase the particular property; and (c) indicia on the remaining front surface containing the name of the real estate firm posting the sign.

### BRIEF DESCRIPTION OF DRAWINGS

FIG. 1 shows a preferred embodiment of the sign of the present invention.

FIG. 2 shows another sign of the preferred embodiment.

### DETAILED DESCRIPTION OF PREFERRED EMBODIMENT

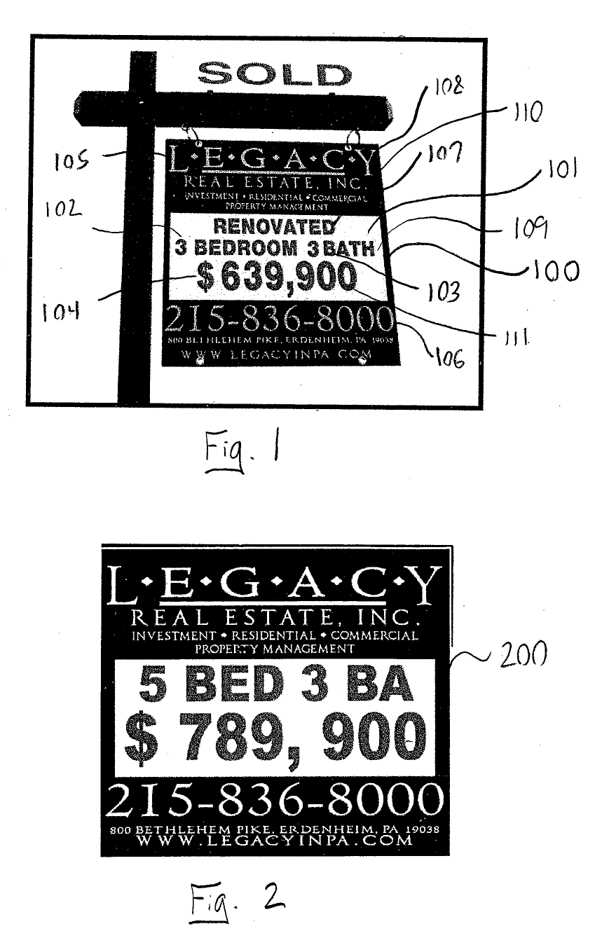

The present invention relates to a method of advertising the sale of a particular real estate property. With reference to FIG. 1, the method comprises preparing a sign 100 which is particular to the particular property (not shown). The sign contains critical information 107, which is (1) unique to the particular property, (2) not readily ascertainable by a person observing the property from a public vantage point, and (3) determinative to a potential buyer's decision to purchase the particular property. Once the sign 100 is prepared, it is posted proximate to the particular property. In a preferred embodiment, the property is residential, although commercial properties are also within the scope of the invention.

As mentioned above, the critical information is unique to the particular property. It is not a general statement for a development or building such as, for example, “Condominiums starting at $200,000.” The critical information is also not readily ascertainable by a person observing the property from a public vantage point. In other words, the critical information serves to supplement the view of the property—it is not intended to state the obvious in view of the property. However, if the property cannot be viewed from a public area (e.g., the building is located down a long private road), then the critical information may include information related to the property's outward appearance. Finally, the information must be critical to a potential buyer's decision to purchase the particular property. This information usually involves price and structural information essential to a buyer's decision to purchase a residence. It should be understood, that the term “buyer” as used herein refers to either a purchaser or a renter. Likewise, the term “price” as used herein refers to either the purchase price or the rental rate.

Critical information may include, for example, one or more of the following parameters: price; rent; number of bed rooms; number of bathrooms; area; existence of one or more of the following: finished basement, pool, carriage house, multiple buildings; subjective qualities such as clean, bright, and open; lot size; zoning information such as sub-dividability, easements, encumbrances, access, restrictions/variations; historical information; prominent architect or designer; recent improves such as remodeled kitchen, renovation; information on kitchen including countertop material, appliances; rental information rental history and relationships between price and rental income.

In a preferred embodiment, the critical information contains three or more of the parameters listed above. These parameters include at least price 104, and, secondarily, at least the number of bedrooms 102 and bathrooms 103.

It is preferable that the sign, not only present the critical information, but also present it in a conspicuous way. Specifically, it should be displayed to be more prominent than the name of the real estate firm posting the sign.

Preferably, the critical information is contained in an information box 101. In a preferred embodiment, the information box 101 occupies at least about ¼ of the area of the sign 100. More preferably, the information box 101 occupies at least about ⅓ of the sign area. Preferably, the name of the real estate firm 105 (which may include a logo) is smaller than the information box 101. More preferably, the name is no greater than ⅔ the size of the information box. It should be understood that, although the term “box” is used herein, it is not intended to be limited to a square or even a strict rectangle, but rather refers broadly to a four-sided area in which the sides are generally, although not necessarily straight. For example, a box having a parallel top and bottom but bowed-out sides is within the meaning of the term box.

Aside from the size of the information box, its position on the sign can also enhance its predominance. In a preferred embodiment, the information box 101 is medially positioned on the sign 100. This way, information 106, other than critical information can be provided above and below the information box 101. Although it is preferred to position the information box in the middle area of the sign, it is not required and, in certain circumstances, it may be preferable to position the information box at the top or on the bottom of the sign's face.

Applicant has found that in addition to size and position, the colors of the information box 101 can have a profound impact on its predominance. In a preferred embodiment, the information box has a first background color 109 and the rest of the sign has at least one second background color 110, in which the first and second background colors are different. It is also preferable, that the second background color 110 frames the information box 101. By framing, applicant means bordering the information box on all sides.

The information box contains the critical information printed in a third color. In a preferred embodiment, each of the first background color and the third color contrasts the second background color. The concept of contrasting colors is well known and one of skill in the art can readily determine contrast and the degree of contrast without undue experimentation.

The indicia on the sign other than those pertaining to the critical information are printed in a fourth color. Preferably, although not necessarily, the third and fourth colors are different. It is not particularly important that the third and fourth colors contrast. Preferably, the contrast between the first background color and the third color is greater than the contrast between the second background color and the fourth color.

Examples of preferred first and second background colors include black, white, dark blue, dark green, and yellow. Still others will be apparent to those of skill in graphic design. Most preferably, the first background color is white and the second background color is black.

Examples of the third color include red, black, yellow, dark blue and dark green. Still others will be apparent to those of skill in graphic design. Most preferably, the third color is red.

What is claimed is:

1. A method of advertising a particular property of real estate comprising:
(a) preparing a sign particular to said particular property, said sign containing critical information which is (1) unique to said particular property, (2) not readily ascertainable by a person observing said property from a public vantage point, and (3) critical to a potential buyer's decision to purchase said particular property; and
(b) posting said sign proximate to said particular property.

2. The method of claim 1, wherein said critical information includes one or more of the following parameters: price; rent; number of bed rooms; number of bathrooms; area; existence of one or more of the following: finished basement, pool, carriage house, multiple buildings; subjective qualities such as clean, bright, and open; lot size; zoning information such as sub-dividability, easements, encumbrances, access, restrictions/variations; historical information; prominent architect or designer; recent improves such as remodeled kitchen, renovation; information on kitchen including countertop material, appliances; rental information rental history and relationships between price and rental income.

3. The method of claim 2, wherein said critical information contains three or more of said parameters.

4. The method of claim 3, wherein said critical information includes at least price.

5. The method of claim 4, wherein said critical information includes at least the number of bedrooms and bathrooms.

6. The method of claim 1, wherein said critical information is more prominent on said sign than the name of the real estate firm posting the sign.

7. The method of claim 6, wherein said critical information is contained in an information box.

8. The method of claim 7, wherein said information box occupies at least about ¼ of the sign area.

9. The method of claim 9, wherein said information box occupies at least about ⅓ of said sign area.

10. The method of claim 7, wherein the name of the real estate firm is smaller than the information box.

11. The method of claim 10, wherein the name includes the name and the logo.

12. The method of claim 11, wherein the name is no greater than ⅔ the size of the information box.

13. The method of claim 7, wherein said information box is medially positioned on said sign.

14. The method of claim 13, wherein information is provided on said sign above and below said information box.

15. The method of claim 7, wherein the information box has a first background color and the rest of the sign has at least one second background color, said first and second background colors being different.

16. The method of claim 15, wherein said second background color frames said information box, and wherein said information box contains said critical information printed in a third color, each of said first background color and said third color contrasting said second background color.

17. The method of claim 16, wherein indicia on said sign other than those pertaining to said critical information is printed in a fourth color, and wherein said third and fourth colors are different.

18. The method of claim 17, wherein said first and second background colors are selected from black, white, dark blue, dark green, and yellow.

19. The method of claim 18, wherein said third color is selected from red, black, yellow, dark blue and dark green.

20. The method of claim 19, wherein the contrast between said first background color and said third color is greater than the contrast between said second background color and said fourth color.

21. The method of claim 20, wherein said first background color is white, said second background color is black, and said third background color is red.
